(19) United States
(12) Patent Application Publication
(10) Pub. No.: US 2023/0387529 A1
(43) Pub. Date: Nov. 30, 2023

(54) MAXIMUM POWER PACK STRUCTURES

(71) Applicant: LilON, LLC, East Dundee, IL (US)

(72) Inventors: Gary GRAY, Tarpon Springs, FL (US); Thomas LYNN, Melvern, PA (US); Christopher Jason MAKSTM, Canton, MI (US)

(73) Assignee: LilON, LLC, East Dundee, IL (US)

(21) Appl. No.: 18/115,385

(22) Filed: Feb. 28, 2023

Related U.S. Application Data
(60) Provisional application No. 63/314,822, filed on Feb. 28, 2022.

(51) Int. Cl. H01M 50/213; H01M 10/613; H01M 50/264

(52) U.S. Cl. CPC H01M 50/213; H01M 10/613; H01M 50/264

(57) ABSTRACT

A support structure for one or more energy storage cells in a power pack, and method of assembling. The support structure may comprise one or more separator walls, a plurality of links, or combinations thereof. The separator walls, links or combinations thereof may be couplable/interlockable to form channels that are configured to receive and at least partially encircle an energy storage cell. Each separator wall may comprise a plurality of troughs that each define a concave surface, and a plurality of ridges, each ridge disposed between adjacent troughs. Each link defines a concave surface and is configured to be releasably coupled/interlocked to another link to form a trough or channel. Each trough is configured to receive and partially encircle an energy storage cell.

### CROSS-REFERENCE TO RELATED APPLICATION

This is a non-provisional US patent application claiming priority under 35 U.S.C. § 119(e) to U.S. Provisional Patent Application No. 63/314,822 filed on Feb. 28, 2022.

### TECHNICAL FIELD

The present disclosure generally relates to support structures for power packs, and more particularly, to support structures for energy storage cells.

### BACKGROUND

Energy storage cells such as rechargeable batteries or the like provide energy solutions for Uninterruptible Power Supplies (UPS) for data centers, telecoms, utilities, solar applications, power grids, portable power, and other applications. Alternative chemistries, such as lithium-ion, lithium sulfur, zinc nickel, aluminum graphite, solid state batteries are effective replacements for lead-acid batteries but are known to generate heat during charging and discharging. Such heat generation may lead to undesirable results that effect the performance of such batteries.

Various temperature control systems have been utilized to force cold air over and around power packs of energy storage cells, and, in some cases, recirculating coolant to cool such energy storage cells and try to limit heat related performance issues. Although these systems may be beneficial, supplemental cooling is desired, especially for power packs of energy storage cells stored in racks or cabinets.

### SUMMARY OF THE DISCLOSURE

In one aspect of the present disclosure, a support structure for one or more energy storage cells in a power pack is disclosed. The support structure may comprise one or more separator walls. Each separator wall may comprise: a plurality of troughs that each define a concave surface; and a plurality of ridges, each ridge disposed between adjacent troughs. Each trough may be configured to receive and partially encircle an energy storage cell.

In another aspect of the disclosure, a method for assembling a support structure for a power pack is disclosed. The method may comprise: forming a plurality of channels, which are each configured to receive and encircle an energy storage cell, by interlocking: (a) a plurality of separator walls, or (b) a plurality of links, or (c) a first separator wall and the plurality of links. In an embodiment, each separator wall may include a plurality of troughs, each link and each trough each may define a concave surface, one or more furrows and one or more plateaus may be disposed on the concave surface of each link, a plurality of furrows and a plurality of plateaus may be disposed on the concave surface of each separator wall, and the energy storage cell may be a battery cell or a superconductor capacitor.

In yet another aspect of the disclosure, a support structure for energy storage cells in a power pack is disclosed. The support structure may comprise: one or more links, each link defining a concave surface. Each link may comprise: a first ridge disposed on a first side of the concave surface; and a second ridge disposed on a second side of the concave surface. The second side may be opposite to the first side. Each link may be configured to be releasably interlocking with another link to form a channel configured to receive and at least partially encircle an energy storage cell.

### BRIEF DESCRIPTION OF THE DRAWINGS

FIG. 1 is a diagrammatic view of one exemplary support structure for cooling a power pack of energy storage cells, according to the present disclosure;

FIG. 2 is a diagrammatic exploded view of the exemplary support structure, of FIG. 1;

FIG. 3 is an enlarged view of the divider wall of the support structure of FIG. 2;

FIG. 4 is a diagrammatic top view of another embodiment of a support structure;

FIG. 5 is a diagrammatic view of another support structure, according to the present disclosure;

FIGS. 6A-6C is a diagrammatic illustration of exemplary (interlockable) links;

FIG. 7 is a diagrammatic illustration of one exemplary plurality of links interlocked to form a channel;

FIG. 8 is a diagrammatic exploded view of another exemplary support structure;

FIG. 9 is another diagrammatic illustration of exemplary embodiments of a plurality of links interlocked to form a support structure;

FIG. 10 is an exemplary flowchart describing a method for assembling a power pack, according to the disclosure; and

FIG. 11 is a diagrammatic top view of another embodiment of a support structure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts, unless otherwise specified.

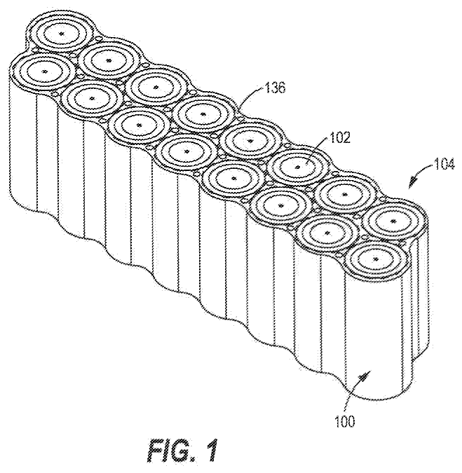

FIG. 1 illustrates one example of a support structure 100 for the cooling of energy storage cells 102 in a power pack 104 of such energy storage cells 102. A power pack 104 is a plurality of interconnected or interconnectable energy storage cells 102 disposed adjacent to each other. Such power packs 104 may be sized for an application based on parameters such as required power, available storage space, or the like. For example, a power pack 104 may include any appropriate quantity of energy storage cells 102, for example, three, four, eight, twelve, sixteen, twenty-four, forty-eight, ninety-six or another appropriate quantity of energy storage cells 102 for an application. Such energy storage cells 102 may be battery cells or superconductor capacitor cells, or the like. An energy storage cell 102 that is a battery cell may be, but is not limited to, a lithium-ion, lithium sulfur, zinc nickel, aluminum graphite or solid state battery cell. Such energy storage cells 102 may be rechargeable. Such power packs 104 may be stored in racks, cabinets, frames or containers, depending on the application, the available storage and the available space.

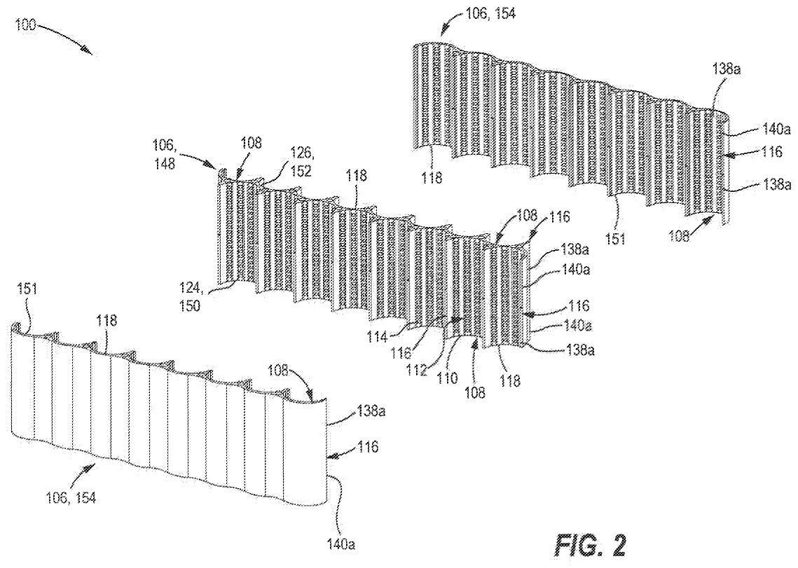

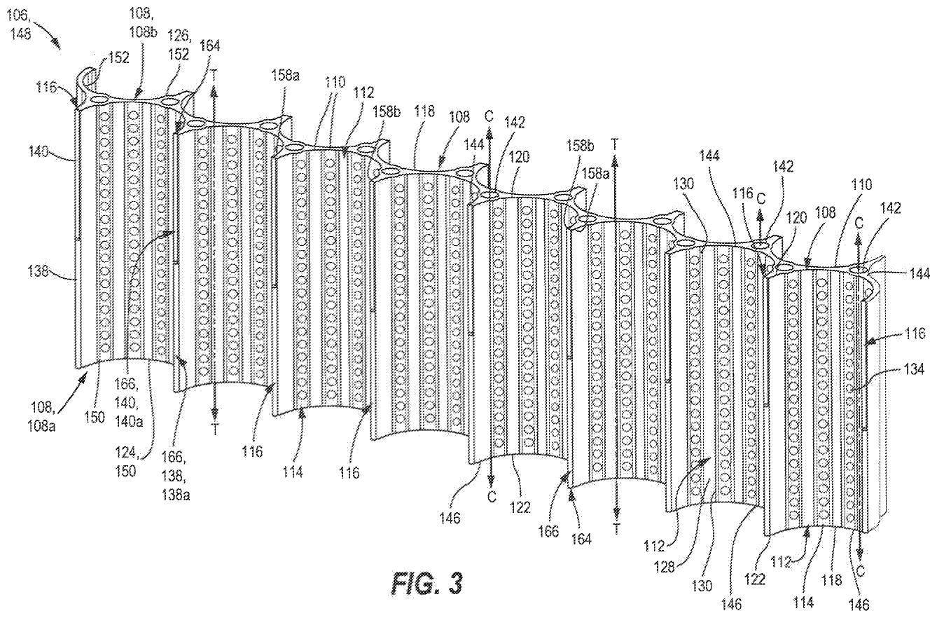

FIG. 2 illustrates an exploded view of the exemplary support structure 100 of FIG. 1. The support structure 100 may comprise one separator wall 106 or plurality of separator walls 106. The plurality of separator walls 106 may be coupled or interlocked together. In an embodiment, the plurality of separator walls 106 may be releasably coupled together or releasably interlocked together. As seen best in FIG. 3, which illustrates an enlarged view of one of the embodiments of a separator wall shown in FIG. 2, the separator wall 106 may comprise a plurality of troughs 108 that each define a concave surface 110, a plurality of furrows 112, a plurality of plateaus 114, and a plurality of ridges 116. Each concave surface 110 defines a concavity 118 that is configured to receive and partially encircle an energy storage cell 102.

The troughs 108 may be oriented in parallel. Each trough 108 is oriented to extend lengthwise along a trough axis T. In an embodiment, each trough axis T (and each trough 108) in the plurality of troughs 108 may be oriented parallel to the other trough axes T (and troughs 108) in the plurality. As shown in FIGS. 2-3, the troughs 108 may be shaped as a half cylinder that is open lengthwise along the trough axis T. In an embodiment, the trough 108 may also be open at the first end 120 (e.g., a top end when viewed) and second end 122 (e.g., a bottom end when viewed) of the trough 108.

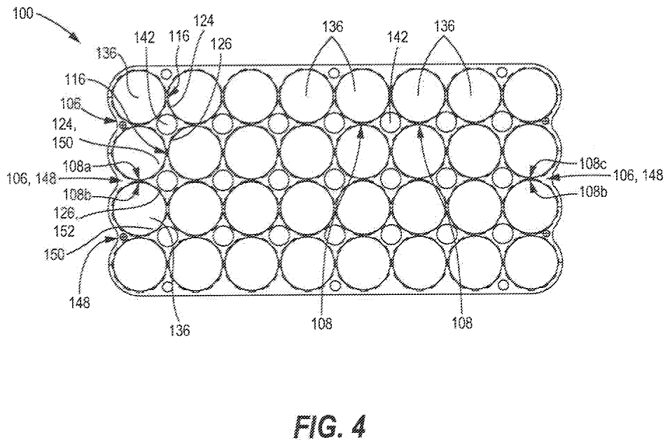

For each separator wall 106, the plurality of troughs 108 may include a first plurality of troughs 108a disposed on the first side 124 of the separator wall 106, and a second plurality of troughs 108b disposed on the second side 126 of the separator wall 106. In some embodiments such as that shown in FIGS. 1-3, but not all embodiments, the troughs 108a disposed on the first side 124 may be offset from the troughs 108b disposed on the second side 126 of the separator wall 106. FIG. 4 illustrates an embodiment of another exemplary support structure 100 that comprises a plurality of separator walls 106 interlocked together. In the embodiment of FIG. 4 a first plurality of troughs 108a disposed on a first side 124 of the separator wall 106 and a second plurality of troughs 108b disposed on a second side 126 of the separator wall 106 are not offset from each other.

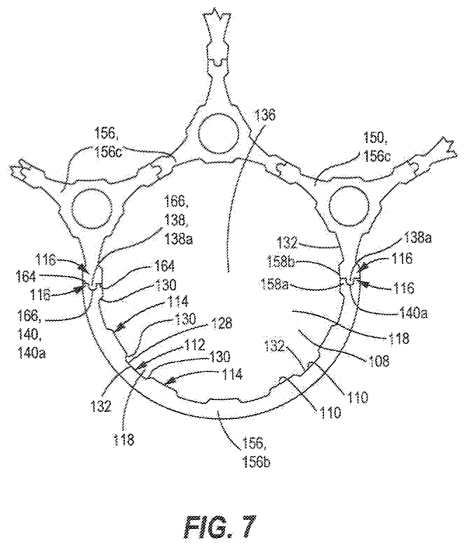

In some embodiments, although not all embodiments, the separator walls 106 may include a plurality of furrows 112. Referring back to FIG. 3, the plurality of furrows 112 disposed in the concave surface 110 may extend from a first end 120 of the trough 108 to a second end 122 of the trough 108. Each furrow 112 includes a floor 128 and a pair of furrow walls 130 (best seen in the embodiment illustrated in FIG. 7). In one embodiment, the furrow walls 130 may each be inclined downward (from the adjacent plateau 114) toward the floor 128. The furrows 130 define a passageway 132 that is configured to receive air from the concavity 118 and route the flow of the air to outside of the trough 108. More specifically, the passageway 132 of each furrow 112 is configured to receive air from the gap between the energy storage cell 102 (when disposed in the channel 136) and the concave surface 110 (e.g., between the energy storage cell 102 and the floor 128 of the furrow 112) and route the flow of such air to outside of the trough 108 (and channel 136). In an embodiment, the furrows 112 may be configured to route such air upward and out of the trough 108 (and channel 136), thus facilitating movement of the warm or hot air away from the energy storage cell 102 disposed in the concavity 118. In an embodiment, one or more furrows 112 on the concave surface 110 may be parallel to each other. In another embodiment, all of the furrows 112 on the concave surface 110 may be oriented in parallel.

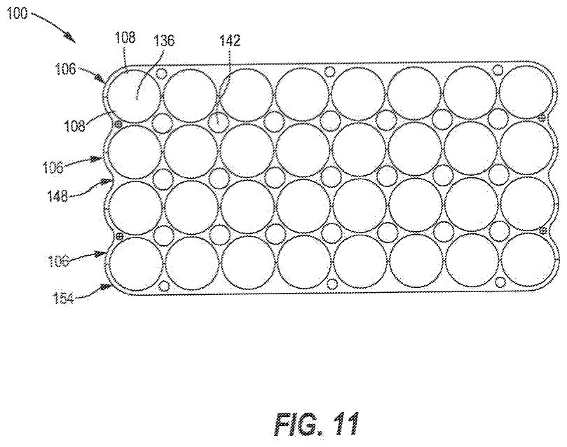

In some embodiments, although not all embodiments, the separator walls 106 may include a plurality of plateaus 114. The plurality of plateaus 114 disposed on the concave surface 110 may extend from the first end 120 (FIG. 3) of the trough 108 (and channel 136) to the second end 122 of the trough 108 (and channel 136). Each plateau 114 may include a plurality of dimples 134. In an embodiment the dimples may be concave dimples 134. The plateaus 114 of each trough 108 are configured to be adjacent to and may be configured to be in contact with an energy storage cell 102 when received in the channel 136 (FIG. 1, FIGS. 4-5, FIG. 7). In some embodiments, the energy storage cells 102 (FIG. 1) received in the channels 136 may be slip fit (slide) into the channels 136. In other embodiments, the energy storage cells 102 may be interference fit into the channels 136. The dimples 134 may be round, polygonal, oval, irregular or another appropriate shape. As used herein, the term “dimple” includes depressions or in some embodiments, extrusions. The dimples 134 help draw warm air away from the energy storage cell 102 and facilitate a turbulence that moves the flow of warm air out of the channel 136. As noted above, in some embodiments, the separator walls 106 may be free of plateaus 114 and/or furrows 112. FIG. 11 illustrates such an embodiment. In FIG. 11, the separator walls 106 are configured without (free of) plateaus 114 and/or furrows 112; this provide additional structural support, vibration protection and harmonic support for energy storage cells 102.

Each ridge 116 (FIG. 3) of the plurality of ridges 116 may be disposed on a side of the concave surface 110 (e.g., between adjacent troughs 108). For example, a first ridge 116 may be disposed on a first edge 158a of the concave surface 110 of the trough 108 and a second ridge 116 may be disposed on a second edge 158b of the concave surface 110 of the trough 108. The first and second edges 158a, 158b extend parallel to the trough axis T in a lengthwise direction of the concave surface 110. The second edge 158b of the concave surface 110 is opposite to the first edge 158a.

Each ridge 116 may include an outer face 164 and one or more fasteners 166. Each fastener 166 may be disposed on/in the outer face 164 or may project outward from the outer face 164. In one embodiment, the fasteners 166 of the ridge 116 may include a first interlocking member 138 and a second interlocking member 140. For example, the first interlocking member 138 may be a tongue 138a that projects outward from the outer face 164 of the ridge 116, and the second interlocking member 140 may be a recess 140a that is disposed in the outer face 164 of the ridge 116.

In some embodiments, the separator wall 106 may further include a conduit 142 centered around a conduit axis C and extending from a first end 144 (e.g., a top end when viewed) of the separator wall 106 to a second end 146 (e.g., a bottom end when viewed) of the separator wall 106. In one embodiment, the conduit 142 may be disposed between a ridge 116 that is disposed on one side (e.g., a first side 124) of the separator wall 106 and the trough 108 that is disposed on the other side (e.g., the second side 126) of the separator wall 106. In another embodiment, the conduit 142 (FIG. 4) may be disposed between a ridge 116 disposed on a first side 124 of the separator wall 106 and another ridge 116 that is disposed on the second side 126 of the separator wall 106 and/or between troughs 108 or channels 136 (FIG. 4).

Referring back to FIG. 2, in a support structure 100, one or more of the separator walls 106 may be divider wall(s) 148. When a separator wall 106 is a divider wall 148, some of the plurality of troughs 108 are disposed on a first side 150 of the divider wall 148 and some of the plurality of troughs 108 are disposed on a second side 152 of the divider wall 148 (the first side 150 of the divider wall 148 opposite to the second side 152 of the divider wall 148). FIG. 3 illustrates one embodiment of a divider wall 148. In some embodiments, the troughs 108 disposed on the first side 150 are offset or staggered from the troughs 108 disposed on the second side 152 of the divider wall 148, as shown in FIG. 3. In other embodiments, the troughs 108 may not be offset but instead may be aligned, as shown in FIG. 4.

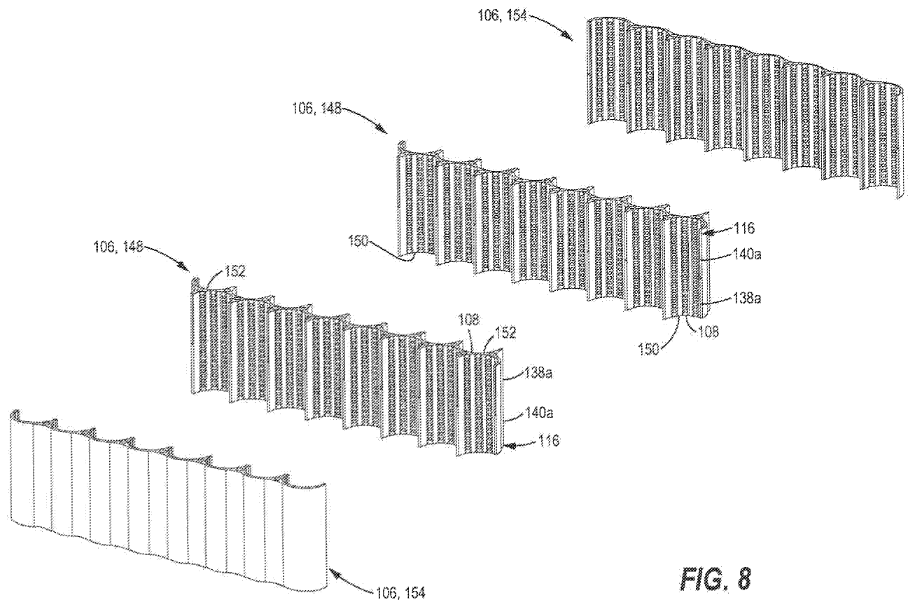

A plurality of divider walls 148 may be coupled/interlocked (in some embodiments, releasably coupled/interlocked) together such that the plurality of troughs 108 of a second side 152 of a first divider wall 148 and the plurality of troughs 108 of a first side 150 of a second divider wall 148 form a plurality of channels 136, each channel 136 configured to receive and encircle an energy storage cell 102. For example as shown in FIG. 8, in one embodiment, the recesses 140a of the ridges 116 of the second side 152 of a first divider wall 148 are configured to receive and lockingly retain (or receive and releasably lockingly retain) the tongues 138a of the ridges 116 of the first side 150 of a second divider wall 148, and the tongues 138a of the ridges 116 of the second side 152 of the first divider wall 148 are configured to be received and lockingly retained (or received and releasably lockingly retained) in the recesses 140a of the ridges 116 of the first side 150 of the second divider wall 148 such that the plurality of troughs 108 of a second side 152 of a first divider wall 148 and the plurality of troughs 108 of a first side 150 of a second divider wall 148 form a plurality of channels 136, each channel 136 configured to receive and encircle an energy storage cell 102. In other embodiments, the ridges 116 may include other fasteners 166 instead of the tongue 138a and recess 140a arrangement.

Referring now to FIG. 2, one or more of the separator walls 106 may be an end wall 154. The plurality of troughs 108 of an end wall 154 are disposed on only one side of the end wall 154, namely the side that will be internal to the support structure 100 (e.g., the internal side 151 may be the side of the end wall 154 that faces a first side 150 (or a second side 152) of a divider wall 148) in an assembled support structure 100). When the separator wall 106 is an end wall 154, the ridges 116 of the divider wall 148 (adjacent to the end wall 154) and the ridges 116 of the end wall 154 are configured to couple/interlock (in some embodiments, releasably couple/interlock) such that the plurality of troughs 108 of the end wall 154 and the plurality of troughs 108 of one side (e.g., in one embodiment the first side 150, in another embodiment the second side 152) of the divider wall 148 form a plurality of channels 136, each channel 136 configured to receive and encircle an energy storage cell 102. More specifically, in one embodiment, the recesses 140a of the ridges 116 of the end wall 154 are reciprocal to the tongues 138a of the ridges 116 of the divider wall 148, and the tongues 138a of the ridges 116 of the end wall 154 are reciprocal to the recesses 140a of the ridges 116 of the divider wall 148. In other embodiments, the ridges 116 may include other interlocking members instead of the exemplary tongue 138a and recess 140a arrangement.

A separator wall 106 may be positioned with the first end 144 of the separator wall 106 (or a first end 120 of the trough 108) above the respective second end 146 of the separator wall 106 (or second end 122 of the trough 108) or vice versa, as necessary for interlocking/coupling separator walls 106.

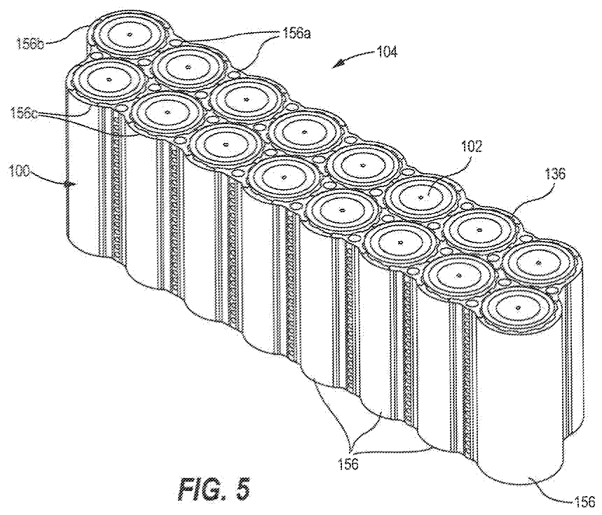

FIG. 5 illustrates an alternative embodiment of a support structure 100 for energy storage cells 102 in a power pack 104. The support structure 100 may comprise links 156 that are coupled/interlocked (in some embodiments, releasably coupled/interlocked) together to form one or more channels 136, each channel 136 configured to receive and encircle an energy storage cell 102.

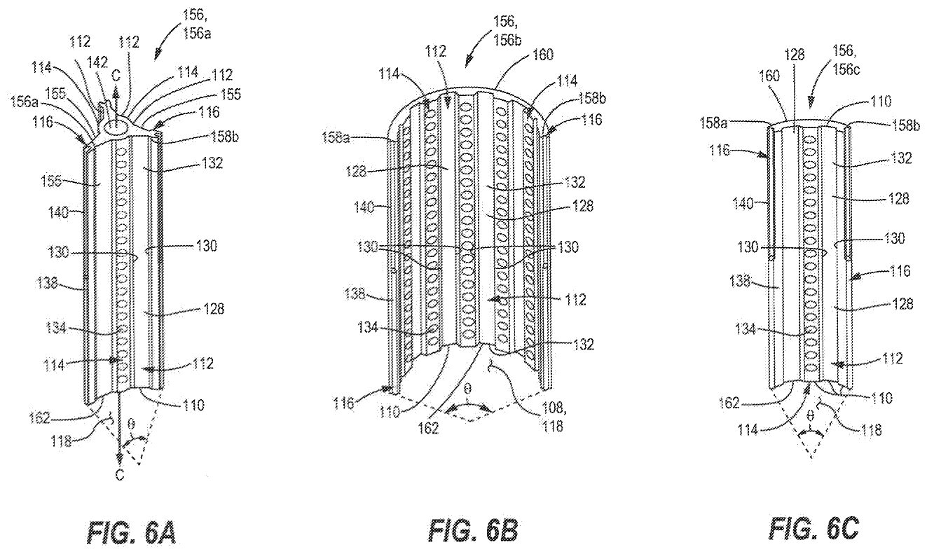

FIGS. 6A-6C illustrate three such exemplary (interlockable) links 156. Each link 156 defines a concave surface 110. Each link 156 may comprise one or more furrows 112 disposed in the concave surface 110 of the link 156, and/or one or more plateaus 114 disposed on the concave surface 110 of the link 156. Each link may comprise a first ridge 116 disposed on a first edge 158a of the concave surface 110 of the link 156, and a second ridge 116 disposed on a second edge 158b of the concave surface 110 of the link 156. The first and second edges 158a, 158b, extending in a lengthwise direction of the concave surface 110. The second edge 158b of the concave surface 110 is disposed opposite to the first edge 158a.

Similar to that described above with regard to divider walls 148, the one or more furrows 112 may extend from a first end 160 (e.g., a top end when viewed) of the link 156 to a second end 162 (e.g., a bottom end when viewed) of the link 156. Each furrow 112 includes a floor 128 and a pair of furrow walls 130. The furrows 112 define a passageway 132 that is configured to receive air from the concavity 118 (FIG. 7) and route the flow of the air to outside of the link 156. More specifically, the links 156 are coupled/interlocked together to form a channel 136. The passageway 132 of each furrow 112 is configured to receive air from the gap between the side of an energy storage cell 102 (when disposed in a channel 136 formed by the links 156) and the floor 128 of the furrow 112 (and the plateaus 114 and dimples 134) and route the flow of such air upward to outside the channel 136, thus facilitating movement of the warm or hot air away from the energy storage cell 102 disposed in the channel 136. In an embodiment, the one or more furrows 112 may be oriented in parallel. In another embodiment, all of the furrows 112 on the concave surface 110 may be parallel.

The plurality of plateaus 114 disposed in the concave surface 110 may extend from a first end 160 to a second end 162 of the link 156 (FIGS. 6A-6C). Each plateau 114 may include a plurality of dimples 134. In an embodiment the dimples may be concave dimples 134. The plateaus 114 of each link 156 are configured to be adjacent to and may be configured to be in contact with an energy storage cell 102 received in the channel 136. In some embodiments, the energy storage cells 102 received in the channels 136 may be slip fit, in other embodiments, the energy storage cells 102 may be interference fit. As discussed herein previously, the dimples 134 may be round, polygonal, oval, irregular or another appropriate shape, and the term “dimple” includes depressions or in some embodiments, extrusions. The dimples 134 help draw warm air away from the energy storage cell 102 and facilitate a turbulence that moves the flow of warm air out of the channel 136 formed by interlocked links 156.

As best seen in FIG. 7, each ridge 116 of a link 156 may include an outer face 164 and one or more fasteners 166. Each fastener 166 may be disposed on/in the outer face 164, or may project outward from the outer face 164. In one embodiment, the fasteners 166 of the ridge 116 of the link 156 may include a first interlocking member 138 and a second interlocking member 140. For example, the first interlocking member 138 may be a tongue 138a that projects outward from the outer face 164 of the ridge 116, and the second interlocking member 140 may be a recess 140a that is disposed in the outer face 164 of the ridge 116 of the link 156.

Each ridge 116 of a link 156 is coupleable/interlockable (or releasably coupleable/interlockable) with a ridge of another link 156. In one embodiment, the recess 140a of the ridge 116 of the first edge 158a of a first link 156 is configured to receive and lockingly retain (or receive and releasably lockingly retain) the tongue 138a of the ridge 116 of the second edge 158b of a second link 156. Similarly, the tongue 138a (see FIGS. 6A-C) of the ridge 116 of the first edge 158a of the first link 156 is configured to be received and lockingly retained (or received and releasably lockingly retained) in a reciprocal recess 140 of the ridge 116 of the second link 156.

As can be seen in FIG. 6A, in an embodiment, the link 156a may have three faces 155 (referred to herein as a “three-sided link”) or sides. In an embodiment, one or more of the three faces 155 of such link 156a may each define a concave surface 110 in/on which one or more furrows 112 or plateaus 114 may be disposed. Each face 155 may have a first ridge 116 disposed on a first edge 158a of the concave surface 110, and a second ridge 116 disposed on a second edge 158b of the concave surface 110. The first and second edges 158a, 158b, extending in a lengthwise direction of the concave surface 110. The second edge 158b of the concave surface 110 is disposed opposite to the first edge 158a. In an embodiment, the link 156a includes the conduit 142 (discussed previously herein). In the embodiment of FIG. 6A, the conduit 142 is centered around an axis C and extends from a first end 160 of the link 156 to a second end 162 of the link 156. In one embodiment, the concavity 118 of a face 155 of link 156a may have a central angle θ of about 30° to about 60°, 30° to 60°, or 60°.

As can be seen in FIG. 6B, in another embodiment, the link 156b may be shaped as a semicircle. In one embodiment of FIG. 6B, the link 156 defines a trough 108 or a concavity 118 that has a central angle θ of about 180°, or 180°.

As can be seen in FIG. 6C, in yet another embodiment, the link 156c may be shaped as a portion of a semi-circle. In one embodiment of FIG. 6C, the link 156 defines a concavity 118 that has a central angle θ of about 30° to about 60°, 30° to 60°, or 60°.

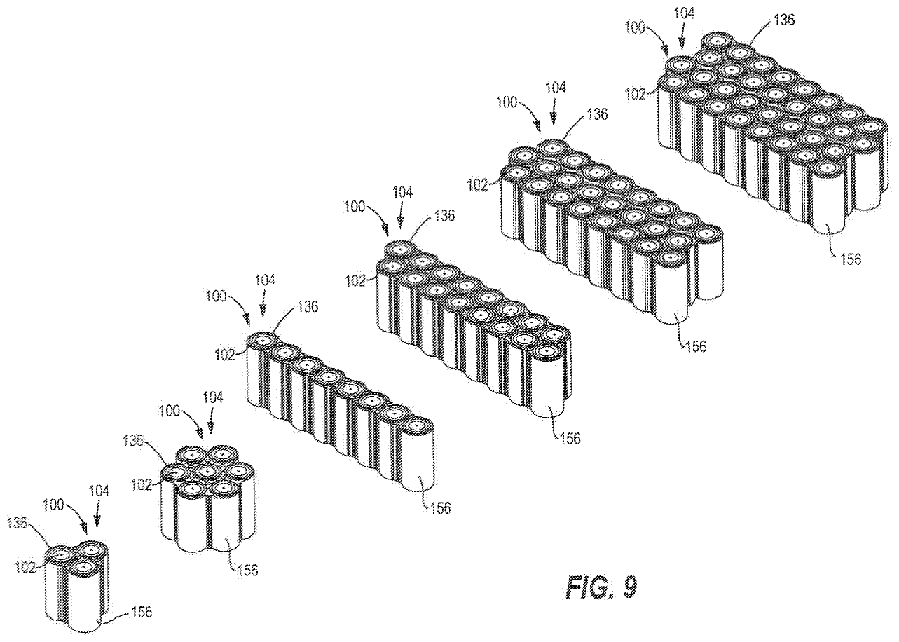

As discussed previously, each link 156 is configured to be coupleable/interlockable (or releasably coupleable/interlockable) with one or more other links 156 to form a channel 136 configured to receive and at least partially encircle an energy storage cell 102. In an embodiment, the channel 136 may be cylinder shaped and have central angle θ of 360°. For example, in the exemplary diagram of FIG. 7, a link 156b shaped as a semicircle is interlocked with three links 156c that are each shaped as a three-sided link 156 to form a channel 136 for an energy storage cell 102 (not shown). Other combinations of the links 156 may be utilized to form a channel 136 or plurality of channels 136. FIG. 9 illustrates a plurality of exemplary combinations of interlocked links 156 that form exemplary support structures 100. In an alternative embodiment, a combination of one or more separator wall(s) 106 and links 156 may be interlocked/coupled (e.g., releasably interlocked/coupled) to form the support structure 100 for a power pack 104.

A link 156 may be positioned with the first end 160 of the link 156 above the respective second end 162 of the link 156 or vice versa, as necessary for interlocking/coupling links 156.

In an embodiment, the separator walls 106 and/or links 156 may be made of plastic (e.g., a fire retardant plastic, thermoplastic polymer (for example, polypropylene), a phase change material that is capable of storing and releasing thermal energy), or other appropriate material such as aluminum that provides support and heat absorption.

Also disclosed is a method for assembling a support structure 100 for a power pack 104, the method comprising: forming a plurality of channels 136, which are each configured to receive and encircle an energy storage cell 102, by interlocking: (a) a plurality of separator walls 106, or (b) a plurality of links 156, or (c) a first separator wall 106 and the plurality of links 156, wherein each separator wall 106 includes a plurality of troughs 108, wherein each link 156 and each trough 108 each define a concave surface 110, wherein one or more furrows 112 and one or more plateaus 114 are disposed on the concave surface 110 of each link 156, wherein a plurality of furrows 112 and a plurality of plateaus 114 are disposed on the concave surface 110 of each separator wall 108, and wherein the energy storage cell 102 is a battery cell or a superconductor capacitor.

### INDUSTRIAL APPLICABILITY

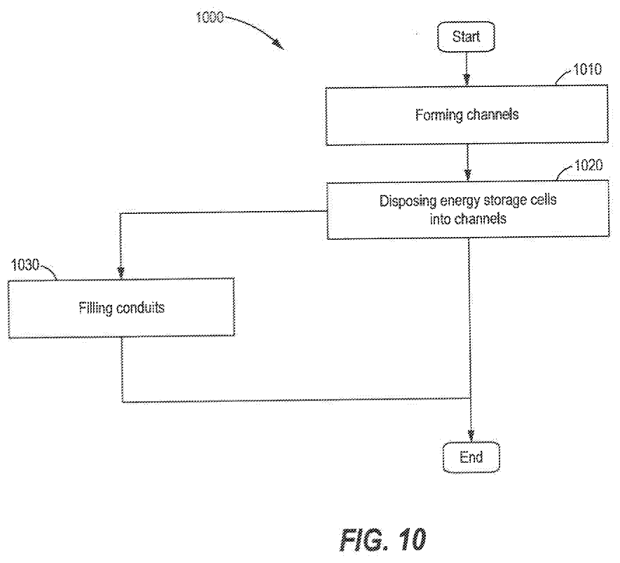

FIG. 10 is an exemplary flowchart describing a method for assembling a power pack 104.

In block 1010, the method includes forming a plurality of channels 136, which are each configured to receive and encircle an energy storage cell 102, by interlocking: (a) a plurality of separator walls 106, or (b) a plurality of links 156, or (c) one or more separator walls 106 and one or more links 156, wherein each separator wall 106 includes a plurality of troughs 108, wherein each link 156 and each trough 108 each define a concave surface 110, wherein one or more furrows 112 and one or more plateaus 114 are disposed on the concave surface 110 of each link 156, wherein a plurality of furrows 112 and a plurality of plateaus 114 are disposed on the concave surface 110 of each separator wall 106, and wherein the energy storage cell 102 is a battery cell or a superconductor capacitor. In an embodiment, a plurality of separator walls 106 may include a pair of end walls 154 and one or more divider walls 148 disposed between the pair of end walls 154. In another embodiment, the plurality of links 156 may include links 156 that have three-sides, and/or or links 156 that are shaped as a portion of a semi-circle, and/or links 156 that are semi-circles. In yet another embodiment, the one or more separator walls 106 may include (a) one or more divider walls 148 and/or end walls 154 and (b) one or more links 156, which may include links 156 that have three-sides, and/or or links 156 that are shaped as a portion of a semi-circle, and/or links 156 that are semi-circles.

In block 1020, the method includes disposing, in a one-to-one correspondence, energy storage cells 102 into the channels 136 so that the plateau(s) 114 of each channel 136 are in close proximity or in contact with a side of the energy storage cell 102. The dimples 134 of each plateau 114 may be configured to route airflow away from the side of the energy storage cell 102. The furrows 112 in each channel 136 are configured to route airflow upward and out of each channel 136.

In block 1030, the method may further include filling the conduits 142 with fluid. In some embodiments, the fluid may be a refrigerant or a heat exchanging fluid. The fluid may be routed through the conduit 142 to remove heat and cool the energy storage cells 102. In other embodiments, in which the power pack 104 is submerged, the fluid may be a dielectric or the like.

In general, the foregoing disclosure finds utility in various applications relating to support structures for energy storage cells. Energy storage cells may generate ohmic heat, active polarization heat and reaction heat during use/discharge. Heated air may cling to the energy storage cells and surfaces adjacent to such energy storage cells, which may result in overheating and diminished performance of the energy storage cells. The support structures disclosed herein are configured to impede thermal propagation between energy storage cells and to promote uniform air flow that reduces heat and heat related stress on the energy storage cells. The support structures herein are configured to channel heated air and ions upward and away from (out of the support structure) the energy storage cells. In embodiments having plateaus, the plateaus provide desired rigidity to the support structure and secure support of the energy storage cells contained in the channels. The plateaus also contribute to damping of vibrations acting on the energy storage cells. Moreover, the couplable/interlockable support structures (separator walls, links) provide the flexible to right size applications. As the number of energy storage cells increase, additional separator walls or links may be added to increase the number of channels available to receive energy storage cells. Similarly, in the event that the quantity of energy storage cells decreases in an application or storage space, the support structures may be resized to have fewer channels. The support structures (separator walls and/or links) may be quickly connected/unconnected which allows for rapid assembly in general and rapid assembly of customized support structures for applications.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A support structure for one or more energy storage cells in a power pack, the support structure comprising:
one or more separator walls, each separator wall comprising:
a plurality of troughs that each define a concave surface; and
a plurality of ridges, each ridge disposed between adjacent troughs,
wherein each trough is configured to receive and partially encircle an energy storage cell.

2. The support structure of claim 1, further comprising:
a plurality of furrows disposed in the concave surface and extend from a first end of the trough to a second end of the trough; and
a plurality of plateaus disposed in the concave surface and extend from the first end of the trough to the second of the trough, each plateau including a plurality of dimples.

3. The support structure of claim 1, wherein the troughs are oriented in parallel.

4. The support structure of claim 1, wherein at least one of the separator walls is a divider wall, wherein further some of the plurality of troughs are disposed on a first side of the divider wall and some of the plurality of troughs are disposed on a second side of the divider wall, the first side of the divider wall opposite to the second side of the divider wall.

5. The support structure of claim 4, wherein the troughs disposed on the first side are offset from the troughs disposed on the second side of the divider wall.

6. The support structure of claim 4, wherein at least one of the separator walls is an end wall, wherein the ridges of the divider wall and the ridges of the end wall are configured to interlock, wherein some of the plurality of troughs are disposed on a internal side of the end wall, the internal side facing a first side of the divider wall, wherein the troughs of the end wall and the troughs of the divider wall form a plurality of channels, each channel configured to receive and encircle an energy storage cell.

7. The support structure of claim 6, further comprising:
a plurality of furrows disposed in the concave surface and extend from a first end of the trough to a second end of the trough; and
a plurality of plateaus disposed in the concave surface and extend from the first end of the trough to the second end of the trough, the plateaus of each trough configured to be in contact with an energy storage cell received in the channel.

8. The support structure of claim 1, wherein the energy storage cell is a battery cell or a superconductor capacitor.

9. A method for assembling a support structure for a power pack, the method comprising:
forming a plurality of channels, which are each configured to receive and encircle an energy storage cell, by interlocking: (a) a plurality of separator walls, or (b) a plurality of links, or (c) a first separator wall and the plurality of links,
wherein each separator wall includes a plurality of troughs,
wherein each link and each trough each define a concave surface,
wherein one or more furrows and one or more plateaus are disposed on the concave surface of each link,
wherein a plurality of furrows and a plurality of plateaus are disposed on the concave surface of each separator wall, and
wherein the energy storage cell is a battery cell or a superconductor capacitor.

10. The method according to claim 9, wherein each plateau includes a plurality of dimples.

11. The method according to claim 9, wherein the plurality of links includes at a first link, the first link including three sides and a conduit extending from a first end of the first link to a second end of the first link.

12. The method according to claim 11, wherein the plurality of links include a second link, the second link shaped as a portion of a semi-circle or as a semicircle

13. The method according to claim 9,
wherein at least one of the plurality of separator walls is a divider wall, wherein further some of the plurality of troughs of the divider wall are disposed on a first side of the divider wall and some of the plurality of troughs are disposed on a second side of the divider wall, the first side of the divider wall opposite to the second side of the divider wall, and
wherein at least one of the plurality of separator walls is an end wall, wherein some of the plurality of troughs of the end wall are disposed on an internal side of the end wall, wherein the troughs of the end wall and the troughs of the divider wall form the plurality of channels.

14. A support structure for energy storage cells in a power pack, the support structure comprising: one or more links, each link defining a concave surface, each link comprising:
a first ridge disposed on a first side of the concave surface; and
a second ridge disposed on a second side of the concave surface, the second side opposite to the first side,
wherein each link is configured to be releasably interlocking with another link to form a channel configured to receive and at least partially encircle an energy storage cell.

15. The support structure of claim 14, in which each link further comprises:
one or more furrows disposed in the concave surface; and
one or more plateaus disposed in the concave surface, each plateau including a plurality of concave dimples.

16. The support structure of claim 15, wherein a first link defines a trough that has a central angle of 40 to 185 degrees, or 55 to 181 degrees, or 60 to 180 degrees.

17. The support structure of claim 16, wherein the first link is a three-sided link.

18. The support structure of claim 16, wherein the first link includes a conduit, the conduit centered around an axis and extending from a first end of the first link to a second end of the first link.

19. The support structure of claim 16, wherein the first link is shaped as a semicircle or a portion of a semi-circle.

20. The support structure of claim 15, wherein the one or more links are a plurality of the links, the plurality of links releasably interlocked to form a plurality of channels, each channel configured to receive and encircle the energy storage cell.
